(19) United States
(12) Patent Application Publication
(10) Pub. No.: US 2009/0132967 A1
(43) Pub. Date: May 21, 2009

(54) LINKED-MEDIA NARRATIVE LEARNING SYSTEM

(75) Inventors: Curtis Glenn Wong, Medina, WA (US); Jonathan Edgar Fay, Woodinville, WA (US)

Correspondence Address: MICROSOFT CORPORATION, ONE MICROSOFT WAY, REDMOND, WA, 98052-6399, US

(73) Assignee: MICROSOFT CORPORATION, Redmond, WA (US)

(21) Appl. No.: 11/941,102

(22) Filed: Nov. 16, 2007

(51) Int. Cl. G06F 3/048

(52) U.S. Cl. 715/854

(57) ABSTRACT

Technologies, architectures, and systems suitable for exploring virtual spaces, objects within the virtual spaces, and information and data related to the virtual spaces and objects. Example virtual spaces include representations of real spaces such as outer space, geographic spaces such as landscaped and the like, atomic and sub-atomic spaces, and the like, and any other real space, as well as any imaginary spaces and any combination of the foregoing. Also provided are example technologies for managing collections of linked narratives related to the virtual spaces and collections of related objects and information and data related to the objects and virtual spaces. Further provided are technologies for linking virtual spaces, linked narratives, objects, and information and data regarding such, and for aiding a user in browsing and navigating between such.

### BACKGROUND

Most spatial exploration tools, such as Microsoft's Virtual Earth and other similar tools, provide a means of exploring spatial environments via multi-resolution terrain rendering. But such tools generally assume an a priori understanding of the space and the motivation to explore the content within the space. For example, to use such tools, one generally needs to know in advance where they wish to look and/or what they are looking for.

### SUMMARY

The following presents a simplified summary of the disclosure in order to provide a basic understanding to the reader. This summary is not an extensive overview of the disclosure and it does not identify all key/critical elements of the invention or delineate the scope of the invention. Its sole purpose is to present some concepts disclosed herein in a simplified form as a prelude to the more detailed description that is presented later herein.

The examples presented herein provide technologies, architectures, and systems suitable for exploring virtual spaces, objects within the virtual spaces, and information and data related to the virtual spaces and objects. Example virtual spaces include representations of real spaces such as outer space, geographic spaces such as landscaped and the like, atomic and sub-atomic spaces, and the like, and any other real space, as well as any imaginary spaces and any combination of the foregoing. Also provided are example technologies for managing collections of linked narratives related to the virtual spaces and collections of related objects and information and data related to the objects and virtual spaces. Further provided are technologies for linking virtual spaces, linked narratives, objects, and information and data regarding such, and for aiding a user in browsing and navigating between such.

Many of the attendant features will be more readily appreciated as the same become better understood by reference to the following detailed description considered in connection with the accompanying drawings.

### DESCRIPTION OF THE DRAWINGS

The present description will be better understood from the following detailed description considered in connection with the accompanying drawings, wherein:

FIG. 1 is block diagram showing an example Interactive Linked Narrative Architecture.

FIG. 2 is a block diagram showing another example of the Interactive Linked Narrative Architecture.

FIG. 3 is a static image example of a linked narrative supported by a Linked Narrative Layer such as described in connection with FIGS. 1 and 2.

FIG. 4 is a static image example of a virtual space presentation interface supported by a Contextual Exploration & Simulation Layer such as described in connection with FIGS. 1 and 2.

FIG. 5 is a block diagram showing an example Interactive Linked Narrative System (“ILNS”) based on the Interactive Linked Narrative Architecture (“ILNA”) described in connection with FIGS. 1 and 2.

FIG. 6 is a block diagram showing an example computing environment in which the technologies described herein may be implemented.

Like reference numerals are used to designate like parts in the accompanying drawings.

### DETAILED DESCRIPTION

The detailed description provided below in connection with the accompanying drawings is intended as a description of the present examples and is not intended to represent the only forms in which the present examples may be constructed or utilized. The description sets forth at least some of the functions of the examples and/or the sequence of steps for constructing and operating examples. However, the same or equivalent functions and sequences may be accomplished by different examples.

Although the present examples are described and illustrated herein as being implemented in a computing environment, the environment described is provided as an example and not a limitation. As those skilled in the art will appreciate, the present examples are suitable for application in a variety of different types of computing environments.

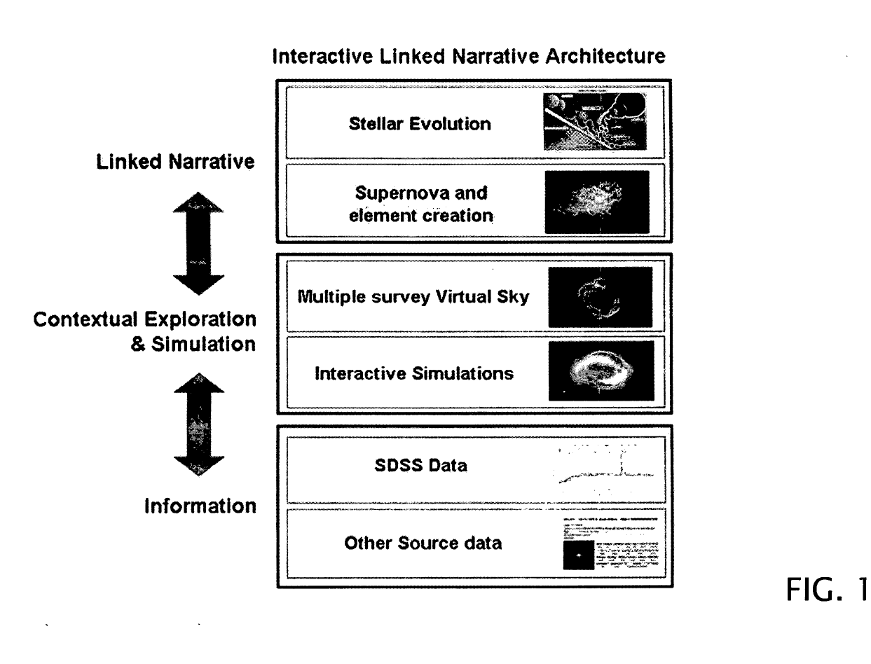

FIG. 1 is block diagram showing an example Interactive Linked Narrative Architecture. The Interactive Linked Narrative Architecture (“ILNA”) typically supports three interlinked layers suitable for providing a deeper understanding of spatial environments and their contents than can be provided by conventional spatial exploration tools. The INLA layers include top or Linked Narrative Layer, the middle or Contextual Exploration & Simulation Layer, and the bottom or Information & Data Layer. The ILNA utilizes these interlinked layers together to present, among other things, a collection of guided tours or linked narratives regarding a spatial environment or virtual space, to present objects within a field of view of the virtual space, and to present various information and data regarding the virtual space and the objects within the virtual space. The term “virtual space” as used herein generally refers to a representation of some space, actual or imaginary, from a particular point of reference, such as outer space (the Earth, for example, being the point of reference) or some other space surrounding a particular point of reference (some point on the Earth, for example). The term “spatial environment” as used herein generally refers to a virtual space, real space, and/or imaginary space. Such spaces may, for example, be galactic, subatomic, or of any scope in-between.

The top layer of the ILNA, or Linked Narrative Layer (“LNL”), typically provides a collection of linked narratives or guided tours. In general, the LNL manages a collection of linked narratives and associated data/metadata along with their presentation to a user via a suitable user interface. Such management may include searching, authoring, browsing, and presentation of linked narratives. Such narratives typically serve to present a topic or topics to a user. Examples, of linked narratives include automated instructional slide presentations, audio/video instructional presentations, podcasts, or any other form of presentation or the like. The topic(s) of a linked narrative generally relate to some aspect of the virtual space(s) with which it is associated. For example, FIG. 1 indicates two example linked narratives, one titled “Stellar Evolution” and another titled “Supernova and element creation”. The terms “linked narrative” and “guided tour” as used herein generally refer to automated or semi-automated presentations including metadata links to related objects in the CESL layer. Such a presentation can typically be paused and restarted.

In one example, linked narratives are a means to engage a user and draw him into the subject matter made available via the ILNA. This is of particular value when the user is unfamiliar with the subject matter or isn't particularly interested in it. Thus linked narratives of the top layer serve as means to establish a reason for a user to care about the subject. Further, linked narratives sstablish a story, character or scene framework from which to begin to organize and remember the information users access regarding a topic.

The middle layer of the ILNA, or Contextual Exploration & Simulation Layer (“CESL”), typically provides a collection of objects present in the virtual space(s) represented by the LNL, each object typically including and/or associated with semantic information such as object type, classification(s), object image(s), and the like. An object may also be associated with other data and/or metadata including presentations, simulations, demonstrations, descriptions, explanations, or the like of which the object is generally a topic. In general, the CESL manages a collection of objects and associated data/metadata along with their presentation to a user via a suitable user interface. Such management may include searching, filtering, authoring, browsing, and presentation of objects and their data/metadata. Further, the CESL typically manages the exploration of a virtual space. That is, the CESL layer presents portions of the virtual space to a user in response to the user's browsing activity, presents object thumbnails to the user that represents objects within the user's current field of view (“FOV”) of the virtual space, and exercises links based on user object selection.

FIG. 1 indicates two example object presentations, one titled “Multiple survey Virtual Sky” and another titled “Interactive Simulations”, each associated with an object or objects not shown. In one example, the virtual space itself may be represented as an object. The term “object” as used herein generally refers to a representation of an entity of a spatial environment. A few examples of such objects include stars, galaxies, nebula, quasars, planets, and any other astronomical object or class of objects, as well as landscapes, or any other entity, real or imaginary, of any spatial environment, real or imaginary.

The bottom layer of the ILNA, or Information & Data Layer (“IDL”), typically provides a collection of information data related to the objects, and/or links to such. Also provided may be links to original source data, references sources, related web sites, and the like. In general, the IDL manages a collection of information and data along with their presentation to a user via a suitable user interface. Such management may include searching, retrieval, authoring, browsing, and presentation of object information and data. A few examples of such data include spectral and magnitude data such as for stars and/or other astronomical objects. Sources of such astronomical data, including image data, include sky surveys, astronomical catalogs, and the like. FIG. 1 indicates two example data, one titled “SDSS Data” (where SDSS stands for the “Sloan Digital Sky Survey”) and another titled “Other Source data”, each related to an object or objects not shown.

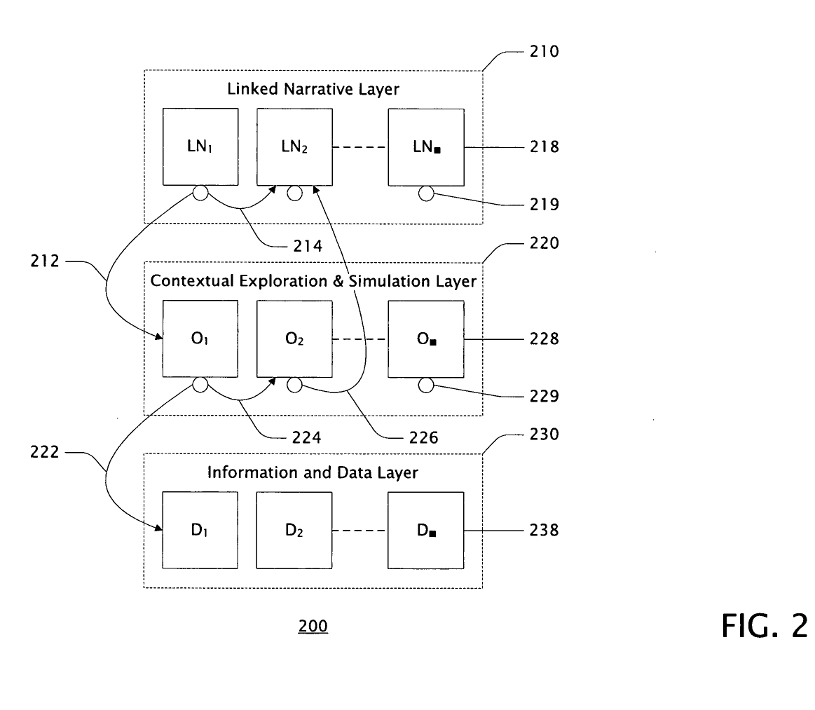

FIG. 2 is a block diagram showing another example of the Interactive Linked Narrative Architecture 200. ILNA 200 includes the upper LNL 210, the middle CESI 220, and the lower IDL 230 as described in connection with FIG. 1. LNL 210 typically includes a collection of linked narratives, as represented by example blocks LN₁ and LN₂ through LNₙ 218. Each linked narrative may include metadata as indicated by the circle at the bottom of each block, such as circle 219. The metadata of a linked narrative may include links to other related linked narratives in LNL 210 (as indicated by example arrow 212) and to related objects in CESL 220 (as indicated by example arrow 214). The term “metadata” as used herein typically refers to data about link narratives of a LNL, objects of a CESL, and/or information or data of an IDL. Such metadata may include keywords, synonyms, categorizations, classifications, reference codes, catalog identifiers, links, universal resource locators (“URL”), and/or the like.

CESL 220 typically includes a collection of objects, as represented by blocks O₁ and O₂ through Oₙ 228. The metadata of an object may include links to related linked narratives in LNL 210 (as indicated by example arrow 226), to other related objects in CESL 220 (as indicated by example arrow 244), and to information and data in IDL 230 (as indicated by example arrow 222).

IDL 230 typically includes a collection of information and data related to objects, such as the data items represented by blocks D₁ and D₂ through Dₙ 238. A data item may be the actual data itself, or it may be a link or the like to the information or data. Not shown in FIG. 2, a data item may be a link to another object or to a linked narrative, typically in some manner related to the data item. In one example, a data item may be a URL to information at a web site. In another example, a data item may be a reference to data in a database. In yet another example, a data item may be the actual data or information versus a link or the like, such as a star's spectral type of alternate catalog names for an object.

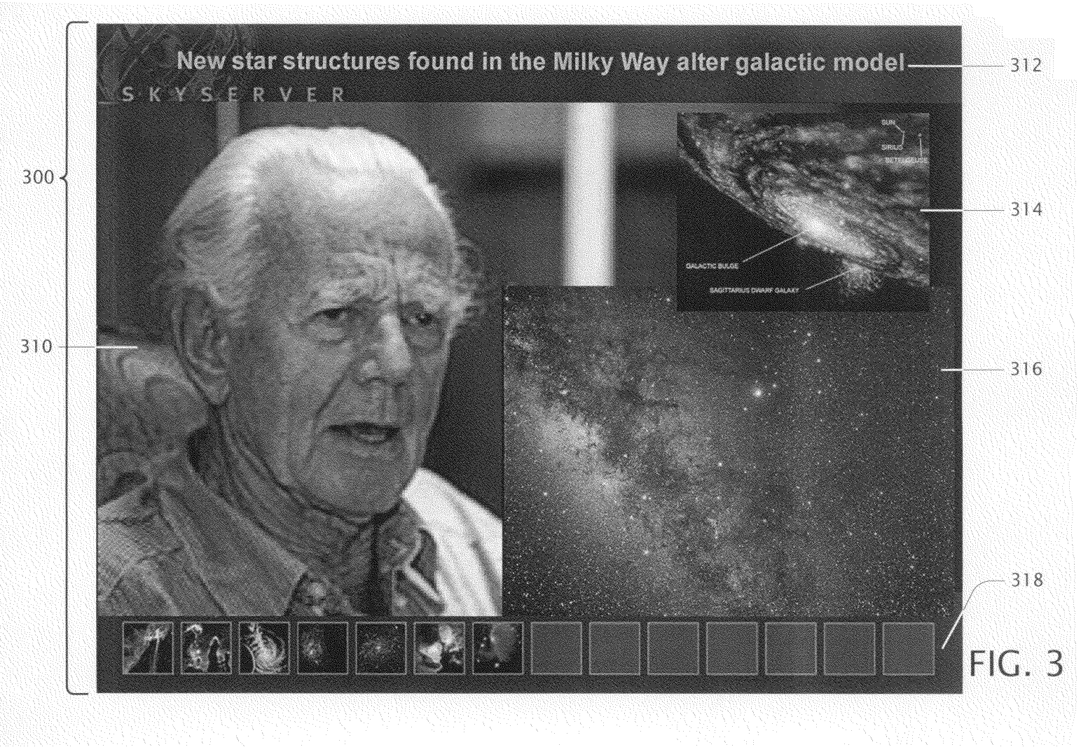

FIG. 3 is a static image example of a linked narrative 300 supported by a Linked Narrative Layer such as described in connection with FIGS. 1 and 2. Example linked narrative 300 includes an audio/video instructional presentation 310 that is titled 312 “New star structures found in the Milky Way alter galactic model”. Included in the presentation are example dynamic overlay images 314 and 316 that may be displayed in relation to relevant portions of presentation 310. Also included is an example contextual object bar 318 showing thumbnail images of objects currently related to the presentation as it progresses. In one example, a user may pause the presentation by selecting an object from object bar 318. Many other type ad styles of linked narrative may also be supported by an LNL including automated instructional slide presentations, audio/video instructional presentations, podcasts, or any other form of presentation or the like.

The object thumbnails displayed in example object bar 318 represent links between linked narrative 300 and objects of the CESL of the ILNA described in connection with FIGS. 1 and 2. In one example, a user may select an object thumbnail to explore the object, thus exercising the link between linked narrative 300 of the LNL and the selected object of the CESL. Similarly, a user may access information and data related to the selected object, the information and data of the IDL of the ILNA, thus exercising links between the selected object of the CESL and information and data of the IDL. Such selecting and accessing may be performed via any suitable user interface mechanism or the like.

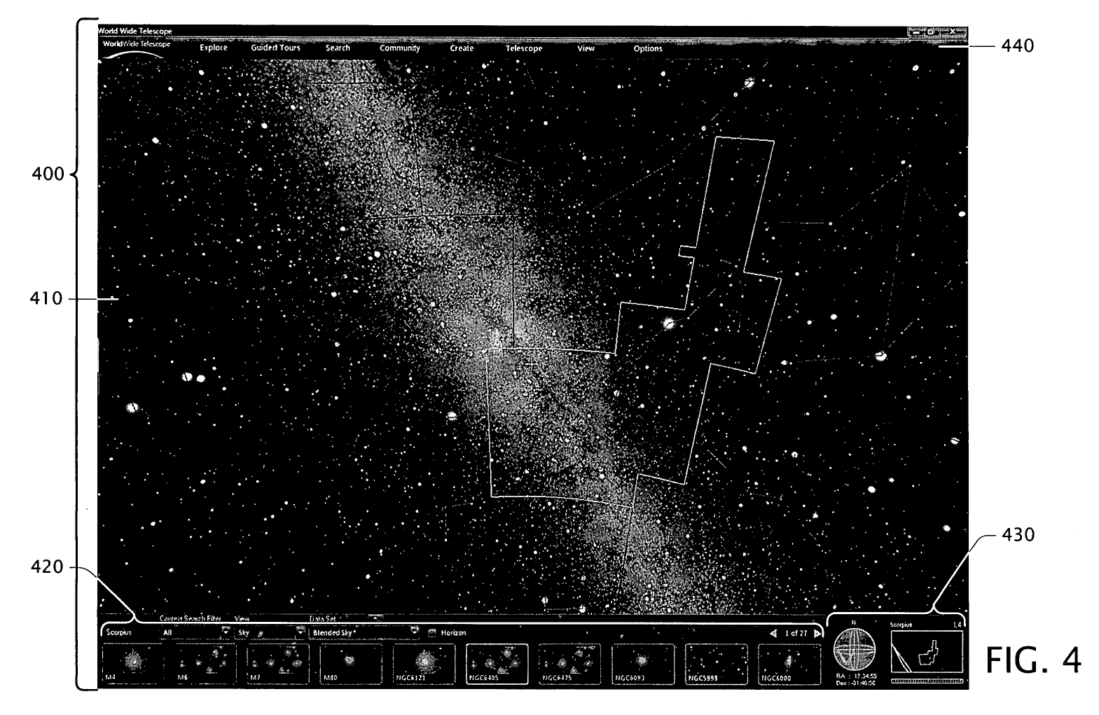

FIG. 4 is a static image example of a virtual space presentation interface 400 supported by a Contextual Exploration & Simulation Layer such as described in connection with FIGS. 1 and 2. Example 400 includes a current field of view (“FOV”) 410 of the virtual space which, in this example, is of outer space. A user may generally explore the virtual space by moving the FOV to a desired location in the virtual space via suitable user interface mechanisms. Further, the user may zoom in or out of the virtual space as desired, thus narrowing or widening the FOV respectively. Example FOV position and zoom indicators 430 may indicate the current FOV within the virtual space to aid user exploration. Other such indicators may alternatively or additionally be used. Example object bar 420 typically presents thumbnail images of objects within the current FOV. A user may select a thumbnail to zoom in on an object and/or access information and data of the IDL associated with the object. Further, a user may use a mouse control or the like to hover over a thumbnail (or otherwise indicate a desired thumbnail) causing the corresponding object in FOV 410 to be indicated, such as by noticeably marking it or highlighting it or the like.

Example menu bar 440 provides a means for users to browse the collection of guided tours or linked narratives managed by the LNL of the INLA as indicated by the “Guided Tours” menu option. Other suitable user interface means or the like may alternatively or additionally be used to browse the collection of guided tours. In one example, selecting the “Guided Tours” menu results in a display of thumbnail images, each such image representing a link narrative. A user can select a desired image to start the corresponding narrative.

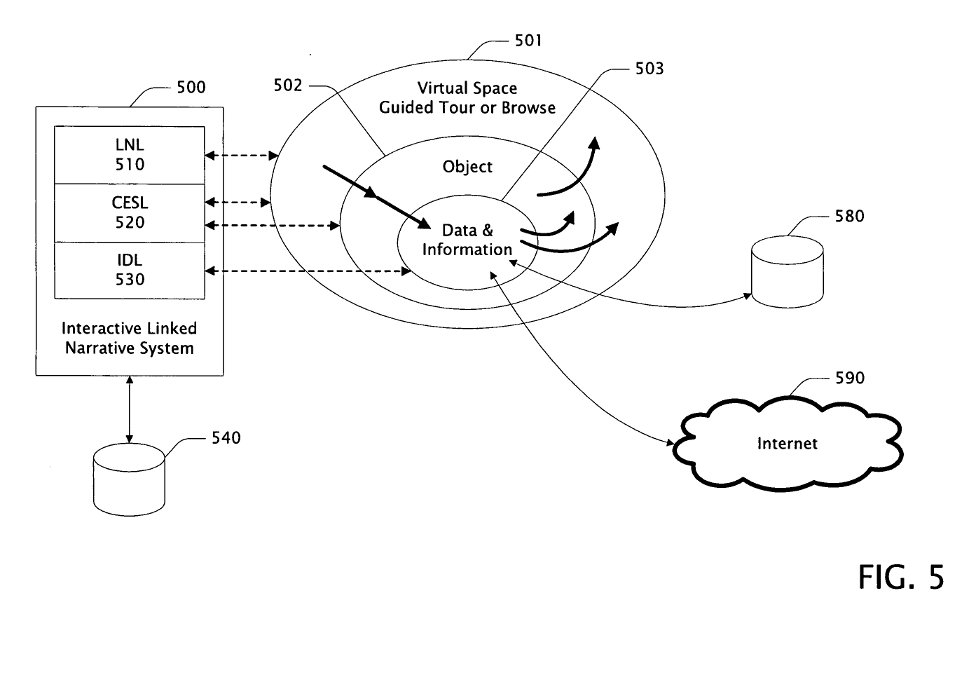

FIG. 5 is a block diagram showing an example Interactive Linked Narrative System (“ILNS”) based on the Interactive Linked Narrative Architecture (“ILNA”) described in connection with FIGS. 1 and 2. In one example, ILNS 500 includes Linked Narrative Layer module 510, Contextual Exploration & Simulation Layer module 520, and Information & Data Layer module 530. In one example, ILNS 500 is implemented as an Internet service. Data store 540 may be one or more data stores of any suitable type which may be included as part of ILNS 500 and/or be external to ILNS 500. Data store 540 typically stores ILNS 500 configuration data, data regarding supported virtual spaces, objects, and object information and data, and other operational data, and the like.

Ovals 501, 502, and 503 represent the three main exploration and navigation levels of ILNS 500 and generally correspond to the three example layers of the ILNA described in connection with FIGS. 1 and 2. Level 501 typically includes a collection of guided tours or linked narratives associated with a virtual space(s), and supports arbitrary browsing of a virtual space(s). The collection of linked narratives and their operation are generally managed by LNL module 510 as indicated by the dashed arrow between LNL module 510 and oval 501. Browsing of a virtual space is generally managed by CESL module 520 as indicated by the dashed arrow between CESL module 520 and level oval 501. Users may move from level 501 of system 500 to level 502, typically by selecting an object in the virtual space or by selecting an object presented in a linked narrative.

Level 502 typically includes a collection of objects related to the virtual space(s) of level 501. Further, level 502 may manage the presentation of simulations, instructional presentations, and the like associated with one or more of the objects. Exploration of objects is generally managed by CESL module 520 as indicated by the dashed arrow between CESL module 520 and level oval 502. Users may move from level 502 of system 500 to level 503 (as indicated by the arrow in FIG. 5 between levels 502 and 503), typically by accessing information and/or data associated with an object. Users may move from level 502 of system 500 to level 501 (as indicated by the arrow in FIG. 5 between levels 502 and 501), typically by selecting a linked narrative.

Level 503 typically includes information and data related to the objects at level 502. Further, level 503 may manage the presentation of information and data associated with one or more of the objects. Object information and data is generally managed by IDL module 530 as indicated by the dashed arrow between IDL module 530 and level oval 503. Users may move from level 503 of system 500 to level 502 (as indicated by the arrow in FIG. 5 between levels 503 and 502), typically by selecting data that is a link to an object or to a virtual space. Users may move from level 503 of system 500 to level 501 (as indicated by the arrow in FIG. 5 between levels 503 and 501), typically by selecting data that is a link to a linked narrative.

LNL module 510 typically manages a collection of linked narratives and associated data/metadata related to one or more virtual spaces as described in connection with the LNL of FIG. 1. The management typically includes the presentation of linked narratives to a user responsive to user selection. CESL module 520 typically manages one or more virtual spaces and a collection of objects and associated data/metadata related to the one or more virtual spaces as described in connection with the CESL of FIG. 1. The management typically includes the presentation of a virtual space and of related objects to a user responsive to user selection. IDL module 530 typically manages data and information related to one or more objects and/or virtual spaces as described in connection with the IDL of FIG. 1. The management typically includes the presentation of information and data to a user responsive to user selection.

Datastore 580 represents one or more data sources from which IDL module 530 may access object information and data. Examples of datastore 580 include databases, electronic catalogs, digital image collections, references sources, and the like. Such datastores may be integrated as a part of system 500 and/or may be remotes and/or intermittently coupled to system 500, such as via a network or the like.

Internet cloud 590 represents one or more Internet-accessible data sources from which IDL module 530 may access object information and data. Examples of Internet-accessible data sources include databases, electronic catalogs, digital image collections, references sources, on-line encyclopedias and dictionaries and other reference material, and the like.

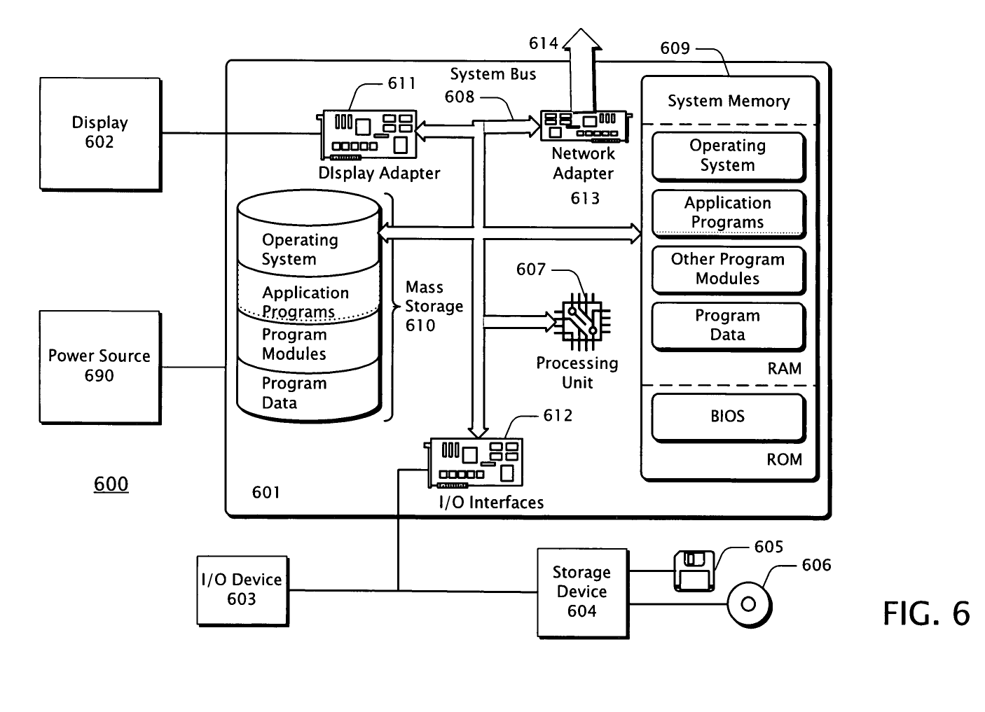

FIG. 6 is a block diagram showing an example computing environment 600 in which the technologies described herein may be implemented. A suitable computing environment may be implemented with numerous general purpose or special purpose systems. Examples of well known systems may include, but are not limited to, cell phones, personal digital assistants (“PDA”), personal computers (“PC”), hand-held or laptop devices, microprocessor-based systems, multiprocessor systems, servers, workstations, consumer electronic devices, set-top boxes, and the like.

Computing environment 600 typically includes a general-purpose computing system in the form of a computing device 601 coupled to various components, such as peripheral devices 602, 603, 604 and the like. System 600 may couple to various other components, such as input devices 603, including voice recognition, touch pads, buttons, keyboards and/or pointing devices, such as a mouse or trackball, via one or more input/output (“I/O”) interfaces 612. The components of computing device 601 may include one or more processors (including central processing units (“CPU”), graphics processing units (“GPU”), microprocessors (“μP”), and the like) 607, system memory 609, and a system bus 608 that typically couples the various components. Processor 607 typically processes or executes various computer-executable instructions to control the operation of computing device 601 and to communicate with other electronic and/or computing devices, systems or environment (not shown) via various communications connections such as a network connection 614 or the like. System bus 608 represents any number of several types of bus structures, including a memory bus or memory controller, a peripheral bus, a serial bus, an accelerated graphics port, a processor or local bus using any of a variety of bus architectures, and the like.

System memory 609 may include computer readable media in the form of volatile memory, such as random access memory (“RAM”), and/or non-volatile memory, such as read only memory (“ROM”) or flash memory (“FLASH”). A basic input/output system (“BIOS”) may be stored in non-volatile or the like. System memory 609 typically stores data, computer-executable instructions and/or program modules comprising computer-executable instructions that are immediately accessible to and/or presently operated on by one or more of the processors 607.

Mass storage devices 604 and 610 may be coupled to computing device 601 or incorporated into computing device 601 via coupling to the system bus. Such mass storage devices 604 and 610 may include non-volatile RAM, a magnetic disk drive which reads from and/or writes to a removable, non-volatile magnetic disk (e.g., a “floppy disk”) 605, and/or an optical disk drive that reads from and/or writes to a non-volatile optical disk such as a CD ROM, DVD ROM 606. Alternatively, a mass storage device, such as hard disk 610, may include non-removable storage medium. Other mass storage devices may include memory cards, memory sticks, tape storage devices, and the like.

Any number of computer programs, files, data structures, and the like may be stored in mass storage 610, other storage devices 604, 605, 606 and system memory 609 (typically limited by available space) including, by way of example and not limitation, operating systems, application programs, data files, directory structures, computer-executable instructions, and the like.

Output components or devices, such as display device 602, may be coupled to computing device 601, typically via an interface such as a display adapter 611. Output device 602 may be a liquid crystal display (“LCD”). Other example output devices may include printers, audio outputs, voice outputs, cathode ray tube (“CRT”) displays, tactile devices or other sensory output mechanisms, or the like. Output devices may enable computing device 601 to interact with human operators or other machines, systems, computing environments, or the like. A user may interface with computing environment 600 via any number of different I/O devices 603 such as a touch pad, buttons, keyboard, mouse, joystick, game pad, data port, and the like. These and other I/O devices may be coupled to processor 607 via I/O interfaces 612 which may be coupled to system bus 608, and/or may be coupled by other interfaces and bus structures, such as a parallel port, game port, universal serial bus (“USB”), fire wire, infrared (“IR”) port, and the like.

Computing device 601 may operate in a networked environment via communications connections to one or more remote computing devices through one or more cellular networks, wireless networks, local area networks (“LAN”), wide area networks (“WAN”), storage area networks (“SAN”), the Internet, radio links, optical links and the like. Computing device 601 may be coupled to a network via network adapter 613 or the like, or, alternatively, via a modem, digital subscriber line (“DSL”) link, integrated services digital network (“ISDN”) link, Internet link, wireless link, or the like.

Communications connection 614, such as a network connection, typically provides a coupling to communications media, such as a network. Communications media typically provide computer-readable and computer-executable instructions, data structures, files, program modules and other data using a modulated data signal, such as a carrier wave or other transport mechanism. The term “modulated data signal” typically means a signal that has one or more of its characteristics set or changed in such a manner as to encode information in the signal. By way of example, and not limitation, communications media may include wired media, such as a wired network or direct-wired connection or the like, and wireless media, such as acoustic, radio frequency, infrared, or other wireless communications mechanisms.

Power source 690, such as a battery or a power supply, typically provides power for portions or all of computing environment 600. In the case of the computing environment 600 being a mobile device or portable device or the like, power source 690 may be a battery. Alternatively, in the case computing environment 600 is a desktop computer or server or the like, power source 690 may be a power supply designed to connect to an alternating current (“AC”) source, such as via a wall outlet.

Some mobile devices may not include many of the components described in connection with FIG. 6. For example, an electronic badge may be comprised of a coil of wire along with a simple processing unit 607 or the like, the coil configured to act as power source 690 when in proximity to a card reader device or the like. Such a coil may also be configure to act as an antenna coupled to the processing unit 607 or the like, the coil antenna capable of providing a form of communication between the electronic badge and the card reader device. Such communication may not involve networking, but may alternatively be general or special purpose communications via telemetry, point-to-point, RF, IR, audio, or other means. An electronic card may not include display 602, I/O device 603, or many of the other components described in connection with FIG. 6. Other mobile devices that may not include many of the components described in connection with FIG. 6, by way of example and not limitation, include electronic bracelets, electronic tags, implantable devices, and the like.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” typically refers to executable instructions, code, data, applications, programs, or the like maintained in an electronic device such as a ROM. The term “software” generally refers to executable instructions, code, data, applications, programs, or the like maintained in or on any form of computer-readable media. The term “computer-readable media” typically refers to system memory, storage devices and their associated media, and the like.

In view of the many possible embodiments to which the principles of the present invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

1. An interactive linked narrative system comprising:
a linked narrative layer module operable to manage a collection of linked narratives and corresponding linked narrative metadata, the corresponding linked narrative metadata including a link to a related object, the collection of linked narratives relating to a virtual space, the managing the collection of linked narratives including providing a means for a user to select a linked narrative of the collection of linked narratives and to present the linked narrative to the user;
a contextual exploration and simulation layer module coupled to the linked narrative layer module and operable to manage a collection of objects and corresponding object metadata, the corresponding object metadata including a link to related information, the managing the collection of objects including providing a means for a user to browse the virtual space, the collection of objects including the related object, the collection of objects being related to the virtual space; and
an information and data layer module coupled to the contextual exploration and simulation layer module and operable to manage a collection of object information and data and corresponding metadata, the corresponding metadata being actual data and/or links to other data, the collection of object information and data being related to the collection of objects.

2. The interactive linked narrative system of claim 1 further comprising digital images representing the virtual space.

3. The interactive linked narrative system of claim 1 further comprising digital images representing one or more objects of the collection of objects.

4. The interactive linked narrative system of claim 1 wherein the linked narrative of the collection of linked narratives is an instructional presentation.

5. The interactive linked narrative system of claim 1 wherein the virtual space represents outer space.

6. The interactive linked narrative system of claim 1 wherein the virtual space represents an imaginary space.

7. A system for exploring a virtual space comprising:
a means for enabling a user to browse the virtual space within a field of view;
a means for zooming in and out of the field of view;
a means for exploring an object within the field of view;
a means of selecting a presentation related to the object; and
a means of accessing information related to the object.

8. The system of claim 7 further comprising links between the presentation and the object and the information.

9. The system of claim 7 further comprising digital images representing the virtual space, portions of the digital images presented within the field of view.

10. The system of claim 7 wherein the virtual space represents outer space.

11. The system of claim 7 wherein the information is sky survey data.

12. The system of claim 7 wherein the virtual space represents a landscape.

13. The system of claim 7 wherein the object represents an astronomical object.

14. The system of claim 13 wherein the object includes an image of the astronomical object.

15. The system of claim 7 wherein the object includes a link to a related object.

16. A virtual space exploration system comprising:
a first module operable to manage a collection of guided tours related to the virtual space;
a second module operable to present a field of view of the virtual space including objects within the virtual space; and
a third module operable to present information related to the virtual space and to the objects within the virtual space.

17. The virtual space exploration system of claim 16 further comprising links between the guided tours and the objects and the information.

18. The virtual space exploration system of claim 16 further comprising a means of accessing the information from the Internet.

19. The virtual space exploration system of claim 16 further comprising a means of zooming in and out of the field of view.

20. The virtual space exploration system of claim 16 wherein the virtual space represents outer space.
